(19) United States
(12) Patent Application Publication
(10) Pub. No.: US 2025/0019602 A1
(43) Pub. Date: Jan. 16, 2025

(54) METHOD OF REFINING WASTE PLASTIC PYROLYSIS OIL AND WASTE PLASTIC PYROLYSIS OIL REFINING EQUIPMENT

(71) Applicants: SK INNOVATION CO., LTD., Seoul (KR); SK GEO CENTRIC CO., LTD., Seoul (KR)

(72) Inventors: Heejung JEON, Daejeon (KR); Okyoun KIM, Daejeon (KR); Kayoung KIM, Daejeon (KR); Youngmoo PARK, Daejeon (KR); Howon LEE, Daejeon (KR)

(21) Appl. No.: 18/705,590

(22) PCT Filed: Nov. 1, 2022
(86) PCT No.: PCT/KR2022/016863

§ 371 Date: Apr. 29, 2024

(30) Foreign Application Priority Data
Nov. 1, 2021 (KR) 10-2021-0148136

(51) Int. Cl. C10G 65/04; B01D 3/10; B01D 3/14; B01J 19/24

(52) U.S. Cl. CPC C10G 65/04; B01D 3/10; B01D 3/143; B01J 19/245; C10G 2300/1003; C10G 2300/202

(57) ABSTRACT

Provided is waste plastic pyrolysis oil refining equipment including: a separation unit which separates a waste plastic pyrolysis oil into a light oil and a heavy oil; a first reactor which hydrotreats the light oil introduced from the separation unit at a temperature of higher than 300° C. and lower than 400° C. in the presence of a hydrotreating catalyst; a separator which removes hydrogen chloride from a reaction product introduced from the first reactor; and a second reactor which removes impurities from the heavy oil introduced from the separation unit at a temperature of higher than 50° C. and lower than 300° C.

### TECHNICAL FIELD

The present disclosure relates to a method of refining a waste plastic pyrolysis oil and waste plastic pyrolysis oil refining equipment.

### BACKGROUND ART

Waste plastics, which are manufactured using petroleum as a raw material, have a low recyclability and are mostly disposed of as garbage. These forms of wastes are decomposed in their natural state, and since the decomposition takes a long time, they pollute the soil and cause serious environmental pollution. As a method of recycling waste plastics, the waste plastics may be pyrolyzed and converted into a usable oil, which is referred to as a waste plastic pyrolysis oil.

However, since a pyrolysis oil obtained by pyrolyzing waste plastics has a high content of impurities such as chlorine, nitrogen, and metal as compared with oils manufactured from crude oil by a common method, it may not be directly used as high value-added petrochemical products such as gasoline and diesel oil and should go through a refining process.

For example, as a refining method for removing impurities such as chlorine, nitrogen, and metal contained in the waste plastic pyrolysis oil, a dechlorination/denitrification method by reacting the waste plastic pyrolysis oil and hydrogen in the presence of a hydrotreating catalyst, a method of removing chlorine contained in the waste plastic pyrolysis oil by adsorption using a chlorine adsorbent, or the like are known.

The waste plastic pyrolysis oil is a mixture of hydrocarbon oils having various boiling points and various molecular weight distributions, and the composition or the reaction activity of impurities in the pyrolysis oil may vary with the boiling point and the molecular weight distribution properties.

Thus, when a refining process is performed for a waste plastic pyrolysis oil whole feed, various process problems may arise. Specifically, since an impurity content in the waste plastic pyrolysis oil is high, an excessive hydrotreatment is performed under excessive operating conditions (high temperature, high pressure), which activates production of an ammonium salt (NH₄Cl). The ammonium salt (NH₄Cl) produced inside the reactor causes corrosion of a reactor to decrease durability, and also causes problems such as differential pressure occurrence and decreased process efficiency.

Conventionally, a technology of separating a crude oil feed by boiling point and then refining it has been performed, but the waste plastic pyrolysis oil and the crude oil have different components and composition ratios from each other, when they are used in the refinement of the waste plastic pyrolysis oil as they are, impurity removal efficiency is deteriorated, and a refined oil satisfying the content of desired components may not be obtained.

Therefore, pyrolysis oil refining equipment and a method of refining a pyrolysis oil, which minimize the content of impurities in the obtained refined oil by separating the waste plastic pyrolysis oil by boiling point and then performing the refining process differently depending on the impurity composition of the separated oil fraction, and suppress or minimize the production of an ammonium salt (NH₄Cl) to secure process stability, in the refining process of a waste plastic pyrolysis oil, are demanded.

### RELATED ART DOCUMENTS

### Patent Documents

Chinese Patent Laid-Open Publication No. 111171865 (May 19, 2020)

### DISCLOSURE

### Technical Problem

An object of the present disclosure is to provide a method of refining a pyrolysis oil and pyrolysis oil refining equipment, having improved process stability by suppressing or minimizing production of an ammonium salt (NH₄Cl) during a refining process.

Another object of the present disclosure is to provide waste plastic pyrolysis oil refining equipment and a method of refining a waste plastic pyrolysis oil, having a minimized content of impurities in a refined oil obtained by performing a refining process differently depending on an impurity composition of a separated oil fraction after separating the waste plastic pyrolysis oil by boiling point.

Still another object of the present disclosure is to provide waste plastic pyrolysis oil refining equipment and a method of refining a waste plastic pyrolysis oil, having improved energy efficiency in conversion into a high value-added petrochemical product, by separating a waste plastic pyrolysis oil by boiling point and then performing a refining process differently depending on an impurity composition of the separated oil fraction.

### Technical Solution

In one general aspect, waste plastic pyrolysis oil refining equipment includes: a separation unit which separates a waste plastic pyrolysis oil into a light oil and a heavy oil; a first reactor which hydrotreats the light oil introduced from the separation unit at a temperature of higher than 300° C. and lower than 400° C. in the presence of a hydrotreating catalyst; a separator which removes hydrogen chloride from a reaction product introduced from the first reactor; and a second reactor which removes impurities from the heavy oil introduced from the separation unit at a temperature of higher than 50° C. and lower than 300° C.

In an exemplary embodiment of the present disclosure, the light oil may have a boiling point of lower than 180° C. and the heavy oil may have a boiling point of higher than 180° C. in the separation unit.

In an exemplary embodiment of the present disclosure, the light oil may contain 800 ppm or more and 3300 ppm or less of chlorine (Cl) and 200 ppm or more and 1100 ppm or less of nitrogen (N), and the heavy oil may contain 200 ppm or more and 500 ppm or less of chlorine (Cl) and 1200 ppm or more and 1700 ppm or less of nitrogen (N), in the separation unit.

In an exemplary embodiment of the present disclosure, a reaction pressure of the first reactor may be 100 bar or less.

In an exemplary embodiment of the present disclosure, the separator may further include a hydrogen gas inlet, and hydrogen chloride may be removed from the reaction product introduced from the first reactor by a hydrogen gas introduced from the hydrogen gas inlet.

In an exemplary embodiment of the present disclosure, the second reactor may include a first reaction area where the heavy oil introduced from the separation unit is dechlorinated in the presence of a hydrotreating catalyst; and a second reaction area where a remaining chlorine component is removed from the reaction product introduced from the first reaction area in the presence of an adsorbent.

In an exemplary embodiment of the present disclosure, the second reactor may perform an impurity removal reaction of the heavy oil introduced from the separation unit in the presence of a solid acid catalyst under an inert atmosphere.

In an exemplary embodiment of the present disclosure, the second reactor may perform the reaction at a pressure of 30 bar or less under a nitrogen atmosphere.

In an exemplary embodiment of the present disclosure, a reforming unit which catalytically reforms a first oil fraction, the first oil fraction from which hydrogen chloride has been removed being introduced from the separator, may be further included.

In an exemplary embodiment of the present disclosure, a fractional distillation unit which separates a second oil fraction into two or more oil fractions having different boiling points and refines the oil fractions, the second oil fraction from which impurities have been removed being introduced from the second reactor, may be further included.

In another general aspect, a method of refining a waste plastic pyrolysis oil includes: separating a waste plastic pyrolysis oil into a light oil and a heavy oil; (a-1) hydrotreating the light oil at a temperature of higher than 300° C. and lower than 400° C. in the presence of a hydrotreating catalyst; (a-2) mixing the hydrotreated light oil with a hydrogen gas to remove hydrogen chloride; and (b-1) removing impurities from the heavy oil at a temperature of higher than 50° C. and lower than 300° C.

In an exemplary embodiment of the present disclosure, the light oil may have a boiling point of lower than 180° C. and the heavy oil may have a boiling point of higher than 180° C.

In an exemplary embodiment of the present disclosure, the light oil may contain 800 ppm or more and 3300 ppm or less of chlorine (Cl) and 200 ppm or more and 1100 ppm or less of nitrogen (N), and the heavy oil may contain 200 ppm or more and 500 ppm or less of chlorine (Cl) and 1200 ppm or more and 1700 ppm or less of nitrogen (N).

In an exemplary embodiment of the present disclosure, the hydrotreating (a-1) may be performed at a reaction pressure of 100 bar or less.

In an exemplary embodiment of the present disclosure, in the removing of impurities (b-1), the heavy oil may be dechlorinated in the presence of a hydrotreating catalyst and then a remaining chlorine component may be removed from the heavy oil in the presence of an adsorbent.

In an exemplary embodiment of the present disclosure, in the removing of impurities (b-1), the heavy oil may be reacted at a pressure of 30 bar or less under a nitrogen atmosphere in the presence of a solid acid catalyst.

In an exemplary embodiment of the present disclosure, (a-3) performing catalytic reforming may be further included, after the further removing of hydrogen chloride (a-2).

In an exemplary embodiment of the present disclosure, (b-2) separating the heavy oil fraction into two or more oil fractions having different boiling points from each other and refining the oil fractions may be further included, after the removing of impurities (b-1).

### Advantageous Effects

The waste plastic pyrolysis oil refining equipment and the method of refining a pyrolysis oil according to the present disclosure have an effect of improving process stability by suppressing or minimizing production of an ammonium salt (NH₄Cl) during a refining process.

In addition, the waste plastic pyrolysis oil refining equipment and the method of refining a pyrolysis oil according to the present disclosure have an effect of minimizing the content of impurities in the obtained refined oil and improving energy efficiency in conversion into a high value-added petrochemical product, by separating a waste plastic pyrolysis oil by boiling point and then performing a refining process differently depending on an impurity composition of the separated oil fraction.

### DESCRIPTION OF DRAWINGS

The above and other objects, features and advantages of the present invention will become apparent from the following description of preferred embodiments given in conjunction with the accompanying drawings, in which:

FIG. 1 is a schematic diagram of a process of separating a waste plastic pyrolysis oil into a light oil and a heavy oil and then refining the oils according to the present disclosure.

### BEST MODE

Hereinafter, the method of refining a waste plastic pyrolysis oil and the waste plastic pyrolysis oil refining equipment according to the present disclosure will be described in detail with reference to the accompanying drawing.

The drawings illustrated in the present specification are provided by way of example so that the idea of the present invention may be sufficiently conveyed to a person skilled in the art. Therefore, the present invention is not limited to the provided drawings, but may be embodied in many different forms, and the drawings may be exaggerated in order to clear the spirit of the present invention.

Technical terms and scientific terms used in the present specification have the general meaning understood by those skilled in the art to which the present invention pertains unless otherwise defined, and a description for the known function and configuration obscuring the gist of the present invention will be omitted in the following description and the accompanying drawings.

The singular form of the term used herein may be intended to also include a plural form, unless otherwise indicated.

The numerical range used in the present specification includes all values within the range including the lower limit and the upper limit, increments logically derived in a form and span in a defined range, all double limited values, and all possible combinations of the upper limit and the lower limit in the numerical range defined in different forms. Unless otherwise defined in the specification of the present invention, values which may be outside a numerical range due to experimental error or rounding of a value are also included in the defined numerical range.

The term “comprise” mentioned in the present specification is an open-ended description having a meaning equivalent to the term such as “is/are provided”, “contain”, “have”, or “is/are characterized”, and does not exclude elements, materials, or processes which are not further listed.

The unit of % used in the present specification without particular mention refers to % by weight, unless otherwise defined.

The ppm mentioned in the present specification refers to mass ppm (wppm) unless otherwise particularly defined.

The boiling point mentioned in the present specification refers to a boiling point (Bp) at a normal pressure.

The hydrotreating catalyst mentioned in the present specification may be any various known kinds of catalysts as long as it is a catalyst which performs a hydrogenation reaction to add hydrogen to a waste plastic pyrolysis oil.

Specifically, the hydrotreating catalyst may include any one or two or more selected from a hydrodesulfurization catalyst, a hydrodenitrification catalyst, a hydrodechlorination catalyst, a hydrodemetallization catalyst, and the like. The catalyst allows the denitrification reaction or the dechlorination reaction to be performed depending on the conditions such as temperature described above simultaneously, as a demetallization reaction is performed. More specifically, the hydrotreating catalyst may be a catalyst including an active metal having hydrotreating catalytic ability, and preferably, may be a catalyst of an active metal supported on a support. Any active metal may be used as long as it has required catalytic ability, and for example, may include any one or more selected from molybdenum, nickel, and the like. Any support may be used as long as it has durability to support the active metal, and for example, may include any one or two or more selected from metal including any one or two or more selected from silicon, aluminum, zirconium, sodium, titanium manganese, and the like; oxides of the metals; and carbon-based materials including any one or two or more selected from carbon black, active carbon, graphene, carbon nanotubes, graphite, and the like; and the like. A specific example may be a catalyst which is a support on which an active metal including 0.1 to 10 wt % of nickel and 0.1 to 30 wt % of molybdenum with respect to the total weight is supported. However, it is only described as a specific example, and the present invention is not interpreted as being limited thereto.

Since a pyrolysis oil obtained by pyrolyzing waste plastics has a high content of impurities such as chlorine, nitrogen, and metal as compared with oils manufactured from crude oil by a common method, it may not be directly used as high value-added petrochemical products such as gasoline and diesel oil and should go through a refining process.

However, when a refining process is performed for a waste plastic pyrolysis oil whole feed, various process problems may arise. Specifically, since an impurity content in the waste plastic pyrolysis oil is high, an excessive hydrotreatment is performed under excessive operating conditions (high temperature, high pressure), which activates production of an ammonium salt (NH₄Cl) production. An ammonium salt (NH₄Cl) produced inside a reactor causes corrosion of the reactor to decrease durability, and also causes problems such as differential pressure occurrence and reduced process efficiency.

Thus, the present disclosure provides waste plastic pyrolysis oil refining equipment including: a separation unit which separates a waste plastic pyrolysis oil into a light oil and a heavy oil; a first reactor which hydrotreats the light oil introduced from the separation unit at a temperature of higher than 300° C. and lower than 400° C. in the presence of a hydrotreating catalyst; a separator which removes hydrogen chloride from a reaction product introduced from the first reactor; and a second reactor which removes impurities from the heavy oil introduced from the separation unit at a temperature of higher than 50° C. and lower than 300° C.

The separation unit is a separation unit which separates a waste plastic pyrolysis oil into a light oil and a heavy oil, the separation may be performed depending on boiling point properties by a distillation method such as atmospheric distillation and reduced pressure distillation, and though it is not necessarily limited thereto, the separation may be performed by a known distillation method. The boiling points of the light oil and the heavy oil may be average boiling points, and the error range may be examined at ±10° C.

The waste plastic pyrolysis oil may include H-naphtha (˜C8, bp<150° C.):Kero (C9-C17, bp 150-265° C.), LGO (C18-C20, bp 265-340° C.), and VGO/AR (C21˜, bp>340° C.) at a weight ratio of 10:90 to 40:60, or 20:80 to 30:70.

In an exemplary embodiment of the present disclosure, the light oil may have a boiling point of lower than 180° C. and the heavy oil may have a boiling point of higher than 180° C. in the separation unit. Specifically, the light oil may include N-naphtha, L-naphtha, and the like having a boiling point of lower than 180° C., and the heavy oil may include kero, LGO, and the like having a boiling point of higher than 180° C.

In an exemplary embodiment of the present disclosure, the light oil may contain 800 ppm or more and 3300 ppm or less of chlorine (Cl) and 200 ppm or more and 1100 ppm or less of nitrogen (N), and the heavy oil may contain 200 ppm or more and 500 ppm or less of chlorine (Cl) and 1200 ppm or more and 1700 ppm or less of nitrogen (N), in the separation unit. Specifically, the light oil may contain 1000 ppm or more and 3000 ppm or less of chlorine (Cl) and 300 ppm or more and 800 ppm or less of nitrogen (N), and the heavy oil may contain 300 ppm or more and 400 ppm or less of chlorine (Cl) and 1300 ppm or more and 1600 ppm or less of nitrogen (N). The light oil containing an excessive amount of chlorine and the heavy oil containing an excessive amount of nitrogen are separated and subjected to a refining process, thereby minimizing production of an ammonium salt (NH₄Cl) so that the process may be stably performed for a long time, and thus, significantly improving process stability.

In the first reactor, the light oil introduced from the separation unit may be hydrotreated at a temperature of higher than 300° C. and lower than 400° C. in the presence of a hydrotreating catalyst. In the reactor, there is a hydrogenation reaction area provided with a hydrotreating catalyst, and a dechlorination, denitrification, desulfurization, or demetallization reaction may be performed. The light oil and a hydrogen gas are introduced to the first reactor, and these are reacted to each other in the presence of a hydrotreating catalyst to perform a hydrogenation reaction. In addition, a reaction to remove a part of olefin and metal impurities from the light oil may also be performed together.

Specifically, when the light oil and the hydrogen gas are introduced to the reaction area in the first reactor, a hydrogenation reaction of a waste plastic pyrolysis oil occurs in the presence of a hydrotreating catalyst, a part of olefin and impurities including chlorine (Cl) and nitrogen (N) are removed from the light oil, other metal impurities are also removed, and a hydrogen chloride (HCl) by-product is produced. A reaction product including the hydrotreated light oil, hydrogen chloride, and unreacted hydrogen gas is introduced to a separator.

As a non-limiting example, a hydrogen n chloride discharge path or a gas discharge path including the same other than the path introduced to the separator may be excluded from the first reactor. That is, the reaction product including the product and the unreactant of the first reactor may be introduced to the separator as it is. As a specific example, it may be preferred that the first reactor has no separate gas outlet.

The reaction temperature of the first reactor may be 300° C. to 400° C., specifically 320° C. to 370° C., and more specifically 340° C. to 360° C. When the range is satisfied, hydrotreating reaction efficiency may be improved.

In an exemplary embodiment of the present disclosure, the reaction pressure of the first reactor may be 100 bar or less. Specifically, in terms of further suppressing the production of an ammonium salt (NH₄Cl), the reaction may be performed at 90 bar or less, or unlimitedly 60 bar or more and 90 bar or less, but it is only presented as an example, and the present disclosure is not interpreted as being limited thereto.

The supply flow rate ratio of the light oil and the hydrogen gas introduced to the first reactor may be any supply flow rate ratio to perform the dechlorination reaction, and for example, a volume flow rate ratio at 1 atm may be 1:300 to 3,000, specifically 1:500 to 2,500. However, it is only presented as an example, and the present disclosure is not interpreted as being limited thereto.

The separator may remove hydrogen chloride from the reaction product introduced from the first reactor. Hydrogen chloride removal efficiency may be improved by separately having a separator which removes hydrogen chloride. Various separators may be used as long as the separator may separate hydrogen chloride from the reaction product and remove it, and for example, a gas-gas separation method by supply of certain gas may be used.

In an exemplary embodiment of the present disclosure, the separator may further include a hydrogen gas inlet, and hydrogen chloride may be removed from the reaction product introduced from the first reactor by a hydrogen gas introduced from the hydrogen gas inlet. Hydrogen chloride is removed by introducing a separate hydrogen gas different from the hydrogen gas included in the reaction product introduced from the first reactor, and the hydrogen chloride is removed by discharging it from the separator. Thus, the first oil fraction from which hydrogen chloride has been removed may be finally produced from the reaction product.

The temperature in the separator is not largely limited since it may be appropriately controlled as long as hydrogen chloride may be removed, and for example, it may be adjusted so that the temperature of the reaction product is 40° C. to 100° C. However, it is only described as a specific example, and the present disclosure is not interpreted as being limited thereto.

The waste plastic pyrolysis oil refining equipment may include a first hydrogen storage tank which supplies a first hydrogen gas to the first reactor and a second hydrogen storage tank which supplies a second hydrogen gas to the separator. Here, the first hydrogen storage tank and the second hydrogen storage tank may be the same hydrogen storage tank or separated hydrogen storage tanks. The first hydrogen gas is introduced from the first hydrogen storage tank to the first reactor and performs a dechlorination reaction with the waste plastic pyrolysis oil. The second hydrogen gas is introduced from the second hydrogen storage tank to the separator and hydrogen chloride is removed from the reaction product.

The second reactor may remove impurities from the heavy oil introduced from the separation unit at a temperature of higher than 50° C. and lower than 300° C. Due to a difference in the content and composition of impurities included in the heavy oil and the light oil, an impurity removal process may be performed under milder conditions than the reaction conditions of the first reactor. Thus, the production of an ammonium salt (NH₄Cl) may be minimized to improve process stability such as an operation time. In addition, when conversion into a Lube base oil product is intended, it is not necessary to decrease the content of nitrogen (N) in the heavy oil due to the nature of the product so that an impurity removal process under excessive conditions does not need to be performed, and thus, it is excellent in terms of energy efficiency. Specifically, it may be performed at temperature of 100 to 250° C., more specifically at temperature of 130 to 200° C. Thus, the second oil fraction from which impurities has been removed may be finally produced from the heavy oil.

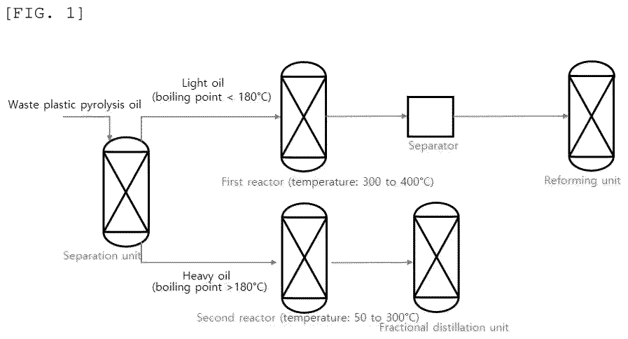

As shown in FIG. 1, since the second reactor and the first reactor are in parallel to the separation unit, the process may be performed independently of each other and a process order is not limited. In addition, the impurity removal process of the second reactor may be performed, for example, in two embodiments, and specifically, may be performed as a process selected from a hydrogenation/adsorption process as a first embodiment and a solid acid catalyst process as a second embodiment. When the impurity removal process is performed by a process selected from the two embodiments, the reaction is performed under milder conditions than the reaction conditions of the first reactor depending on the content and composition of impurities of the heavy oil, which is the effect described above, thereby minimizing the production of an ammonium salt (NH₄Cl) to efficiently achieve the effect of improving process stability such as improved operating time.

In an exemplary embodiment of the present disclosure, as a first embodiment of the second reactor, the second reactor may include a first reaction area where the heavy oil introduced from the separation unit is dechlorinated in the presence of a hydrotreating catalyst; and a second reaction area where a remaining chlorine component is removed from the reaction product introduced from the first reaction area in the presence of an adsorbent.

The first reaction area is an area dechlorination reaction is performed in the presence of a hydrotreating catalyst, and the heavy oil and a hydrogen gas are introduced into the second reactor and are reacted with each other in the presence of the hydrotreating catalyst to perform a dechlorination reaction. In addition, a reaction to remove a part of olefin and metal impurities may also be performed.

The reaction product is introduced from the first reaction area to the second reaction area, and remaining chlorine (Cl) may be further removed in the presence of an adsorbent. Thus, chlorine removal efficiency may be increased.

The adsorbent may be various kinds as long as it may adsorb a chlorine component in the heavy oil. Specifically, the adsorbent may include any one or two or more selected from metal oxides, metal hydroxides, metal carbides, and the like. The metal of the metal oxide, the metal hydroxide, or the metal carbide of the adsorbent may include any one or two or more selected from calcium, magnesium, aluminum, iron, and the like. More specifically, the adsorbent may include any one or two or more selected from calcium oxide, magnesium oxide, aluminum oxide, iron oxide (Fe₃O₄, Fe₂O₃), calcium hydroxide, magnesium hydroxide, aluminum hydroxide, iron hydroxide, iron carbide (Fe—C composite), calcium carbide (CaH—C composite), and the like. However, it is only described as an example, and is not limited thereto.

The second reaction area may be designed to be provided with an adsorbent and bring the reaction product including the heavy oil into contact with the adsorbent. Specifically, an adsorption layer filled with a plurality of adsorbents is provided at a specific thickness, so that the reaction product passes through the adsorption layer from top to bottom to perform adsorption. More specifically, the average thickness of the adsorption layer may be properly adjusted depending on the flow rate of the reaction product, the size of the inside of the reactor, a required processing speed, and the like, and for example, may be 0.5 to 10 cm, specifically 1 to 5 cm. However, it is only described as an example, and is not limited thereto.

The temperature conditions of the first embodiment of the second reactor may be higher than 50° C. and lower than 300° C., specifically, at a temperature of 100 to 250° C., and more specifically, at a temperature of 130 to 200° C. Pressure conditions may be 100 bar or less, and specifically, in terms of further suppressing the production of an ammonium salt (NH₄Cl), the reaction may be performed at 60 bar or less, and unlimitedly, at 30 bar to 60 bar, but it is only presented as an example, and the present disclosure is not interpreted as being limited thereto. The supply flow rate ratio of the heavy oil and the hydrogen gas may be any supply flow rate ratio to perform the dechlorination reaction, and for example, a volume flow rate ratio at 1 atm may be 1:300 to 3,000, specifically 1:500 to 2,500. However, it is only described as an example, and is not limited thereto.

In an exemplary embodiment of the present disclosure, as the second embodiment of the second reactor, the second reactor may perform an impurity removal reaction of the heavy oil introduced from the separation unit in the presence of a solid acid catalyst under an inert atmosphere.

The solid acid catalyst includes a Bronsted acid, a Lewis acid, or a mixture thereof, and specifically, may be a solid material in which a Bronsted acid or a Lewis acid site is present, and specifically, may be zeolite, clay, silica-alumina-phosphate (SAPO), aluminum phosphate (ALPO), metal organic framework (MOF), silica alumina, or a mixture thereof.

The solid acid catalyst may be included at 5 to 10 wt %, specifically 7 to 10 wt %, and more specifically 8 to 10 wt %, with respect to the total weight of the heavy oil. Within the range, as the amount of the solid acid catalyst introduced is increased, a chlorine (Cl) and nitrogen (N) removal effect is improved, and when the amount is 10 wt % or less, a cracking reaction in the heavy oil may be suppressed.

The temperature conditions of the second embodiment of the second reactor may be higher than 150° C. and lower than 300° C., specifically higher than 170° C. and lower than 270° C. When the temperature range described above is satisfied, a nitrogen (N) reduction effect as well as a chlorine (Cl) reduction effect is increased.

In an exemplary embodiment of the second embodiment of the second reactor, the second reactor may perform the reaction at a pressure of 30 bar or less under a nitrogen atmosphere. It is advantageous to perform the reaction under the nitrogen atmosphere in terms of safety and economic feasibility. Similar Cl reduction performance is shown even under air conditions, but when leak occurs under high operation conditions at higher than 150° C., there is a risk of fire, and though Cl reduction efficiency is increased under H₂ conditions, economic feasibility is lowered by the use of H₂ as compared with N₂ operation. When the process is performed under the conditions of 30 bar or more, a production rate of an ammonium salt (NH₄Cl) is increased and process costs are increased. Unlimitedly, the reaction may be performed at a pressure of 2 bar or more, and when the reaction is performed in low vacuum conditions of less than 2 bar or high vacuum conditions, a catalyst pyrolysis reaction occurs to decrease the viscosity and the molecular weight of the pyrolysis oil and change the composition of the heavy oil.

In an exemplary embodiment of the present disclosure, the waste plastic pyrolysis oil refining equipment may further include a reforming unit which catalytically reforms a first oil fraction, the first oil fraction from which hydrogen chloride has been removed being introduced from the separator. The first oil fraction from which hydrogen chloride has been removed from the separator includes a light oil component, which is catalytically reformed to be converted into a high value-added petrochemical product such as BTX and light olefin. Catalytic reforming may be performed by a conventionally known method, and for example, may be performed by a contact reforming method of performing the reaction by bringing the first oil fraction into contact with a catalyst containing a precious metal such as platinum and rhenium, but it is only described as an example and the present disclosure is not limited thereto.

In an exemplary embodiment of the present disclosure, the waste plastic pyrolysis oil refining equipment may further include a fractional distillation unit which separates a second oil fraction into two or more oil fractions having different boiling points and refines the oil fractions, the second oil fraction from which impurities have been removed being introduced from the second reactor. The second oil fraction from which impurities have been removed from the second reactor includes a heavy oil component, which may be separated by boiling point and converted into a high value-added petrochemical product such as lube base oil or fuel. The fractional distillation method may be performed by a conventionally known method, and for example, may be performed by a method such as atmospheric distillation and reduced pressure distillation, but it is only described as an example and the present disclosure is not limited thereto.

The method of refining a waste plastic pyrolysis oil according to the present disclosure may include: separating a waste plastic pyrolysis oil into a light oil and a heavy oil; (a-1) hydrotreating the light oil at a temperature of higher than 300° C. and lower than 400° C. in the presence of a hydrotreating catalyst; (a-2) mixing the hydrotreated light oil with a hydrogen gas to remove hydrogen chloride; and (b-1) removing impurities from the heavy oil at a temperature of higher than 50° C. and lower than 300° C.

The waste plastic pyrolysis oil may include H-naphtha (˜C8, bp<150° C.):Kero (C9-C17, bp 150-265° C.), LGO (C18-C20, bp 265-340° C.), and VGO/AR (C21˜, bp>340° C.) at a weight ratio of 10:90 to 40:60, or 20:80 to 30:70.

The separating of a waste plastic pyrolysis oil into a light oil and a heavy oil may be performed based on a certain boiling point (bp) by a known fractional distillation method such as atmospheric distillation and reduced pressure distillation, and the present disclosure is not limited thereto. The boiling points (bp) of the light oil and the heavy oil may be average boiling points, and the error range may be examined at ±10° C.

In an exemplary embodiment of the present disclosure, the light oil may have a boiling point of lower than 180° C. and the heavy oil may have a boiling point of higher than 180° C. Specifically, the light oil may include N-naphtha, L-naphtha, and the like having a boiling point of lower than 180° C., and the heavy oil may include kero, LGO, and the like having a boiling point of higher than 180° C.

In an exemplary embodiment of the present disclosure, the light oil may contain 800 ppm or more and 3300 ppm or less of chlorine (Cl) and 200 ppm or more and 1100 ppm or less of nitrogen (N). Specifically, 1000 ppm or more and 3000 ppm or less of chlorine (Cl) and 300 ppm or more and 800 ppm or less of nitrogen (N) may be contained. The heavy oil may contain 200 ppm or more and 500 ppm or less of chlorine (Cl) and 1200 ppm or more and 1700 ppm or less of nitrogen (N). Specifically, 300 ppm or more and 400 ppm or less of chlorine (Cl) and 1300 ppm or more and 1600 ppm or less of nitrogen (N) may be contained. The light oil containing an excessive amount of chlorine and the heavy oil containing an excessive amount of nitrogen are separated to perform the refining process, thereby minimizing the production of an ammonium salt (NH₄Cl) to improve process stability such as improved operating time.

In the hydrotreating (a-1), the light oil may be hydrotreated at a temperature of higher than 250° C. and lower than 400° C. in the presence of a hydrotreating catalyst. A dechlorination, denitrification, desulfurization, or demetallization reaction may be performed by the hydrotreating reaction. The light oil and hydrogen gas are reacted with each other in the presence of a hydrotreating catalyst to perform a hydrogenation reaction, thereby removing a part of olefin and impurities of chlorine (Cl) and nitrogen (N), removing other metal impurities, and producing a hydrogen chloride (HCl) by-product.

The reaction temperature of the hydrotreating (a-1) may be 300° C. to 400° C., specifically 320° C. to 370° C., and more specifically 340° C. to 360° C. When the range is satisfied, hydrotreating reaction efficiency may be improved.

In an exemplary embodiment of the present disclosure, the reaction pressure of the hydrotreating (a-1) may be 100 bar or less. Specifically, in terms of further suppressing the production of an ammonium salt (NH₄Cl), the reaction may be performed at 90 bar or less, or unlimitedly 60 bar or more and 90 bar or less, but it is only presented as an example, and the present disclosure is not interpreted as being limited thereto.

The supply flow rate ratio of the light oil and the hydrogen gas in the hydrotreating (a-1) may be any supply flow rate ratio to perform the dechlorination reaction, and for example, a volume flow rate ratio at 1 atm may be 1:300 to 3,000, specifically 1:500 to 2,500. However, it is only described as an example, and the present invention is not interpreted as being limited thereto.

In the removing of hydrogen chloride (a-2), the hydrotreated light oil may be mixed with hydrogen gas to remove hydrogen chloride. Specifically, the reaction product including the hydrotreated light oil, hydrogen chloride, and unreacted hydrogen gas may be reacted with a separate hydrogen gas to remove hydrogen chloride from the reaction product. The removing of hydrogen chloride is further performed, thereby improving hydrogen chloride removal efficiency.

The temperature of the removing of hydrogen chloride (a-2) is not largely limited since it may be appropriately controlled as long as hydrogen chloride may be removed, and for example, it may be adjusted so that the temperature of the reaction product is 40 to 100° C. However, it is only described as a specific example, and the present disclosure is not interpreted as being limited thereto.

In the removing of impurities (b-1), impurities may be removed from the heavy oil at a temperature of higher than 50° C. and lower than 300° C. Due to the difference in the content and composition of impurities between the heavy oil and the light oil, the impurity removal process may be performed under milder conditions than the conditions of (a-1), thereby minimizing the production of an ammonium salt (NH₄Cl) to improve process stability improved operating time. In addition, when conversion into a Lube base oil product is intended, it is not necessary to decrease the content of nitrogen (N) in the heavy oil so that an impurity removal process under excessive conditions does not need to be performed, and thus, it is excellent in terms of energy efficiency. Specifically, it may be performed at a temperature of 100 to 250° C., more specifically at a temperature of 130 to 200° C. Thus, the second oil fraction from which impurities has been removed may be finally produced from the heavy oil.

The steps (a-1) and (a-2) and the step (b-1) may be independently performed, and the reaction order is not limited thereto. In addition, the removing of impurities (b-1) may be performed, for example, in two embodiments, and specifically, may be performed as a process selected from a hydrogenation/adsorption process as a first embodiment and a solid acid catalyst process as a second embodiment. When the removing of impurities is performed by a process selected from the two embodiments, the reaction is performed under milder conditions depending on the content and composition ratio of impurities of the heavy oil, which is the effect described above, thereby minimizing the production of an ammonium salt (NH₄Cl) to efficiently achieve the effect of improving process stability such as improved operating time.

In an exemplary embodiment of the present disclosure, in the removing of impurities as the first embodiment of (b-1), the heavy oil may be dechlorinated in the presence of a hydrotreating catalyst and then a remaining chlorine component may be removed in the presence of the hydrotreating catalyst.

The heavy oil and the hydrogen gas are reacted with each other in the presence of the hydrotreating catalyst to perform a dechlorination reaction and remove a part of olefin and metal impurities. Further, a step of further removing a remaining chlorine component from the reaction product of the dechlorination reaction in the presence of an adsorbent is performed, thereby increasing chlorine removal efficiency.

The adsorbent may be various kinds as long as it may adsorb a chlorine component in the heavy oil. As a specific example, the adsorbent may include any one or two or more selected from metal oxides, metal hydroxides, metal carbides, and the like. The metal of the metal oxide, the metal hydroxide, or the metal carbide of the adsorbent may include any one or two or more selected from calcium, magnesium, aluminum, iron, and the like. As a specific example, the adsorbent may include any one or two or more selected from calcium oxide, magnesium oxide, aluminum oxide, iron oxide (Fe₃O₄, Fe₂O₃), calcium hydroxide, magnesium hydroxide, aluminum hydroxide, iron hydroxide, iron carbide (Fe—C composite), calcium carbide (CaH—C composite), and the like. However, this is described as a preferred example, and the present invention is not interpreted as being limited thereto.

The temperature conditions of the first embodiment of (b-1) may be higher than 50° C. and lower than 300° C., specifically, at a temperature of 100 to 250° C., and more specifically, at a temperature of 130 to 200° C. Pressure conditions may be 100 bar or less, and specifically, in terms of further suppressing the production of an ammonium salt (NH₄Cl), the reaction may be performed at 60 bar or less, and unlimitedly, at 30 bar to 60 bar, but it is only presented as an example, and the present disclosure is not interpreted as being limited thereto. The supply flow rate ratio of the heavy oil and the hydrogen gas may be any supply flow rate ratio to perform the dechlorination reaction, and for example, a volume flow rate ratio at 1 atm may be 1:300 to 3,000, specifically 1:500 to 2,500. However, it is only described as an example, and the present invention is not interpreted as being limited thereto.

In an exemplary embodiment of the present disclosure, in the removing of impurities as the second embodiment of (b-1), the heavy oil may be reacted at a pressure of 30 bar or less under a nitrogen atmosphere in the presence of a solid acid catalyst.

The solid acid catalyst includes a Bronsted acid, a Lewis acid, or a mixture thereof, and specifically, may be a solid material in which a Bronsted acid or a Lewis acid site is present, and specifically, may be zeolite, clay, silica-alumina-phosphate (SAPO), aluminum phosphate (ALPO), metal organic framework (MOF), silica alumina, or a mixture thereof.

The solid acid catalyst may be included at 5 to 10 wt %, specifically 7 to 10 wt %, and more specifically 8 to 10 wt %, with respect to the total weight of the heavy oil. Within the range, as the amount of the solid acid catalyst introduced is increased, a chlorine (Cl) and nitrogen (N) removal effect is improved, and when the amount is 10 wt % or less, a cracking reaction in the heavy oil may be suppressed.

The temperature conditions of the second embodiment of (b-1) may be higher than 150° C. and lower than 300° C., specifically higher than 170° C. and lower than 270° C. When the temperature range described above is satisfied, a nitrogen (N) reduction effect as well as a chlorine (Cl) reduction effect is increased.

In an exemplary embodiment of the second embodiment of (b-1), in the removing of impurities (b-1), the heavy oil may be reacted at a pressure of 30 bar or less under a nitrogen atmosphere in the presence of a solid acid catalyst. It is advantageous to perform the reaction under the nitrogen atmosphere in terms of safety and economic feasibility. Similar Cl reduction performance is shown even under air conditions, but when leak occurs under high operation conditions at higher than 150° C., there is a risk of fire, and though Cl reduction efficiency is increased under H₂ conditions, economic feasibility is lowered by the use of H₂ as compared with N₂ operation. When the process is performed under the conditions of 30 bar or more, a production rate of an ammonium salt (NH₄Cl) is increased and process costs are increased. Unlimitedly, the reaction may be performed at a pressure of 2 bar or more, and when the reaction is performed in low vacuum conditions of less than 2 bar or high vacuum conditions, a catalyst pyrolysis reaction occurs to decrease the viscosity and the molecular weight of the pyrolysis oil and change the composition of the heavy oil.

In an exemplary embodiment of the present disclosure, the method of refining a waste plastic pyrolysis oil may further include (a-3) performing catalytic reforming, after the further removing of hydrogen chloride (a-2). After removing hydrogen chloride from the light oil, the light oil may be catalytically reformed to be converted into a high value-added petrochemical product such as BTX and light olefin. The catalytic reforming may be performed by a conventionally known method, and for example, may be performed by a contact reforming method of performing the reaction by bringing the first oil fraction into contact with a catalyst containing a precious metal such as platinum and rhenium, but it is only described as an example and the present disclosure is not limited thereto.

In an exemplary embodiment of the present disclosure, the method of refining a waste plastic pyrolysis oil may further include (b-2) separating the heavy oil fraction into two or more oil fractions having different boiling points from each other and refining the oil fractions, after the removing of impurities (b-1). After removing impurities from the heavy oil, the heavy oil may be separated by boiling point and converted into a high value-added petrochemical product such as lube base oil or fuel. The fractional distillation method may be performed by a conventionally known method, and for example, may be performed by a method such s atmospheric distillation and reduced pressure distillation, but it is only described as an example and the present disclosure is not limited thereto.

Hereinafter, the present invention will be described in detail by the Examples, however, the Examples are for describing the present invention in more detail, and the scope of the present invention is not limited to the following Examples.

### Example 1

1-1) Separation Unit Separating Naphtha and Kero Oil Fraction from Waste Plastic Pyrolysis Oil

Waste plastics were pyrolyzed to obtain a pyrolysis oil containing a high concentration of impurities of 706 ppm of chlorine (Cl), 1081 ppm of nitrogen (N), 30 vol % or more of olefin, and 1 vol % or more of conjugated diolefin. The molecular weight distribution of the pyrolysis oil was confirmed by GC-Simdis (HT 750) analysis. The analysis results are shown in the following Table 1.

TABLE 1

| | Expected | Boiling | |
|---|---|---|---|
| | carbon | point | Yield |
| Cut Name | range | (° C.) | (wt %) |
| Naphtha | C7-C9 | 80-150 | 22.1 |
| KERO | C10-C17 | 150-265 | 28.1 |
| LGO | C18~C20 | 265-340 | 15.9 |
| VGO/AR | C21~ | >340 | 33.3 |
| SUM | — | — | 100 |

In order to recover a light oil and a heavy oil which may be converted into a high value-added petrochemical product, the oils were separated by boiling points by a distillation device. The light oil was obtained by separating an oil fraction having a boiling point of lower than 180° C. at normal pressure (hereinafter, referred to as H-naphtha), and the heavy oil was obtained by separating an oil fraction having a boiling point of higher than 180° C. (hereinafter, referred to as Kero+) by reduced pressure distillation.

The contents of impurities Cl and N of the waste plastic pyrolysis oil whole feed, the separated H-naphtha, and the Kero+ oil fraction were confirmed by ICP, TNS, EA-O, and XRF analyses. The analysis results are shown in the following Table 2.

TABLE 2

| | Cl (wppm) | N (wppm) | Weight (%) |
|---|---|---|---|
| Waste plastic pyrolysis | 706 | 1081 | 100 |
| oil whole feed | | | |
| H-naphtha | 1195 | 957 | 22.1 |
| Kero+ | 494 | 1545 | 77.9 |

### 1-2) First Reactor and Separator

### 1-2-1) First Reactor Reducing Cl and N by Hydrotreatment of H-Naphtha Oil Fraction

The separated H-naphtha oil fraction was put into the first reactor provided with NiMo/r-Al₂O₃ and Como/r-Al₂O₃ catalysts which were hydrotreating catalysts inside. The H-naphtha oil fraction and hydrogen gas each introduced into the first reactor were reacted to remove chlorine (Cl), nitrogen (N), olefin, metal impurities, and the like, thereby producing hydrogen chloride as a by-product.

1-2-2) Separator Removing Hydrogen Chloride from Hydrotreated H-Naphtha Oil Fraction

A reaction product including H-naphtha from which a chlorine component had been removed in the first reactor, hydrogen chloride, and unreacted hydrogen gas was put into the separator. Then, a separate hydrogen gas was put into the separator through a hydrogen gas inlet, and among the reaction product present in the separator, hydrogen chloride was replaced with the hydrogen, and discharged from the separator and removed.

### 1-3) Second Reactor Removing Impurities of Kero+ Oil Fraction—First Embodiment: Hydrogenation/Adsorption

The separated Kero+ oil fraction was put into the second reactor provided with a molybdenum sulfide (MOS)-based catalyst which was a hydrotreating catalyst. Inside the second reactor, a first reaction area where the Kero+ oil fraction and the hydrogen gas were reacted was formed in the upper portion of the second reactor, and a second reaction area adsorbed by an adsorption layer (layer volume: 2 cc, layer thickness: 2.5 cm) filled with calcium oxide particles (particle diameter: 0.55 mm) using chlorine in the reaction product introduced from the first reaction area as an adsorbent was formed in the lower portion of the second reactor.

The Kero+ oil fraction and the hydrogen gas were put into the upper portion of the second reactor to allow the Kero+ oil fraction and the hydrogen gas to be reacted in the first reaction area in the second reactor, thereby removing a chlorine component from the Kero+ oil fraction. The Kero+ oil fraction from which the chlorine component had been removed was put into the second reaction area in the second reactor to adsorb a remaining chlorine component in the Kero+ oil fraction by the adsorbent and remove it.

The operating conditions of the first reactor, the separator, and the second reactor are shown in the following Table 3.

TABLE 3

| | First | | Second |
|---|---|---|---|
| | reactor | Separator | reactor |
| Reaction | Cl removal, | HCl removal | Cl removal |
| | N removal | | |
| Temperature (° C.) | 350 | 70 | 150 |
| Pressure (bar) | 80 | 1 | 60 |
| H₂/oil ratio | 1200 | 840 | 840 |
| Liquid hourly | 0.7 h⁻¹ | 0.07 h⁻¹ | 0.4 h⁻¹ |
| space velocity | | | |
| (LHSV) | | | |

### Examples 2 and 3—Change of Temperature and Pressure Conditions

The process was performed in the same manner as in Example 1, except that among the operating conditions of the first reactor and the second reactor, the reaction temperature and pressure conditions were changed as shown in the following Table 4.

TABLE 4

| | Example 2 | | Example 3 | |
|---|---|---|---|---|
| | First | Second | First | Second |
| | reactor | reactor | reactor | reactor |
| Temperature (° C.) | 320 | 120 | 380 | 100 |
| Pressure (bar) | 80 | 70 | 90 | 50 |

### Example 4—Impurity Removal Process from Kero+ Oil Fraction—Second Embodiment Solid Acid Catalyst

The process was performed in the same manner as in Example 1, except that an impurity removal process by a solid acid catalyst was performed, instead of the first embodiment. As the solid acid catalyst, an E-cat catalyst having an average particle size of 80 μm formed of 40 wt % of zeolite, 50 wt % of clay, and 10 wt % of silica gel, alumina gel, and functional material was used as the solid acid catalyst.

25 parts by weight of the solid acid catalyst with respect to 100 parts by weight of the separated Kero+ oil fraction was put into the second reactor, and the reaction was performed to obtain a refined oil from which impurities had been removed.

The reaction conditions of the second reactor of the second embodiment are shown in the following Table 5.

TABLE 5

| | Second reactor |
|---|---|
| Reaction | Removal of Cl and N |
| Temperature (° C.) | 250 |
| Pressure (bar) | 5 |
| Oil ratio | N₂/Oil ratio 700 |
| Liquid hourly space velocity (LHSV) | 0.6 h⁻¹ |

### Comparative Example 1—Performing Impurity Removal Process of H-Naphtha and Kero Oil Fraction by the Same Means

The process was performed in the same manner as in Example 1, except that impurity removal process of the Kero+ oil was performed under the same means and conditions as the hydrotreating process of the H-naphtha oil fraction.

### Comparative Example 2—Performing Impurity Removal Process for Whole Feed

A refined oil was obtained by a process of removing impurities for the whole feed, without separating H-naphtha and Kero+ oil fraction from the waste plastic pyrolysis oil. The hydrotreating process (1-2-1, 1-2-2) of the H-naphtha oil fraction of Example 1 was performed in the same manner as in Example 1, except that the process was performed at 350° C. under 180 bar.

### Comparative Example 3—Performing Impurity Removal Process by Separating Based on Boiling Point of 265° C.

The process was performed in the same manner as in Example 1, except that the waste plastic pyrolysis oil was separated into a light oil (hereinafter, referred to as kero−) having a boiling point of lower than 265° C. and a heavy oil (hereinafter, referred to as LGO+) having a boiling point of 265° C. or higher, which were recovered.

### Evaluation Example 1—Measurement of Impurity Content and Maximum Driving Time

The contents of Chlorine (Cl) and nitrogen (N) which were the impurities in the finally obtained refined oil were evaluated by ICP, TNS, EA-O, and XRF analyses, through Examples 1 to 5 and Comparative Examples 1 to 3.

In addition, an amount of time during which operation may be performed without a pressure drop problem was measured to evaluate an ammonium salt (NH₄Cl) suppression effect. Specifically, the refined oil was continuously produced by the equipment of each of the examples and the comparative examples, and at this time, a maximum operating time taken until a pressure loss (delta P) by the ammonium salt (NH C1) was 7 bar was measured, and the results therefor are shown in the following Table 6.

TABLE 6

| | | Examples | | | | Comparative Examples | | | | |
|---|---|---|---|---|---|---|---|---|---|---|
| | | 1 | 2 | 3 | 4 | 1 | 2 (whole feed) | | 3 | |
| Boiling point reference | | 150 | 150 | 150 | 150 | 150 | — | | 265 | |
| temperature (° C.) | | | | | | | | | | |
| T1: First reactor reaction | | 350 | 320 | 380 | 350 | 350 | 350 | | 350 | |
| temperature (° C.) | | | | | | | | | | |
| P1: First reactor reaction | | 80 | 80 | 90 | 80 | 80 | 180 | | 80 | |
| pressure (bar) | | | | | | | | | | |
| T2: Second reactor | | 150 | 120 | 100 | 250 | 350 | — | | 150 | |
| reaction temperature (° C.) | | | | | | | | | | |
| P2: Second reactor | | 60 | 70 | 50 | 5 (N₂) | 80 | — | | 60 | |
| reaction pressure (bar) | | | | | | | | | | |
| Light oil | Cl in | 2 | 1 | <1 | 2 | 2 | Cl in | 2 | Kero− | 43 |
| (H-Naphtha) | refined oil | | | | | | refined | | | |
| | (wppm) | | | | | | oil | | | |
| | N in | 5 | 3 | <1 | 4 | 6 | (wppm) | | Kero− | 19 |
| | refined oil | | | | | | | | | |
| | (wppm) | | | | | | | | | |
| Heavy oil | Cl in | 221 | 177 | 93 | 2 | 59 | N in | 13 | LGO+ | 280 |
| (Kero+) | refined oil | | | | | | refined oil | | | |
| | (wppm) | | | | | | (wppm) | | | |
| | N in | 1330 | 1150 | 835 | 11 | 395 | | | LGO+ | 119 |
| | refined oil | | | | | | | | | |
| | (wppm) | | | | | | | | | |

| Maximum operating time | >14 | >14 | >13 | 15> | <7 | <7 | 4 |
|---|---|---|---|---|---|---|---|
| (day) until pressure loss | | | | | | | |

In Examples 1 to 4, it was confirmed that the content of chlorine (Cl) in the refined oil obtained from the light oil (H-naphtha) was all 2 ppm or less, the content of nitrogen (N) therein was all 6 ppm or less, and in particular, in Example 3, the contents of chlorine and nitrogen were all significantly decreased to 1 ppm or less. However, it was confirmed that the content of nitrogen (N) in the refined oil obtained from the whole feed of Comparative Example 2 was 13 ppm, and thus, the content of nitrogen which was an impurity was significantly increased in the case of the whole feed. In addition, it was confirmed that the content of chlorine (Cl) in the refined oil obtained from the light oil (kero−) having a boiling point of lower than 265° C. of Example 3 was 43 ppm, the content of nitrogen (N) therein was 19 ppm, and thus, the impurity contents were significantly increased as compared with Examples 1 to 4.

In summary, in Examples 1 to 5, it was confirmed that a high-quality refined oil having excellently reduced contents of chlorine (Cl) and nitrogen (N) was obtained from the light oil (H-naphtha), and in particular, in Example 4, a high-quality refined oil having significantly reduced contents of chlorine and nitrogen as impurities was obtained from both the light oil (H-naphtha) and the heavy oil (kero+).

In addition, in Examples 1 to 4, it was confirmed that the maximum operating time was all 13 days or more, so that the process may be stably performed for a long time.

However, in Comparative Example 1, it was confirmed that since the first reactor and the second reactor performed the reaction under the conditions of a high temperature of 350° C., an ammonium salt (NH₄Cl) occurred and a reaction differential pressure was increased, so that the maximum operating time was significantly shortened to 7 days or less. In Comparative Example 2 also, it was confirmed that the refining process was performed for the waste plastic pyrolysis oil whole feed, so that the maximum operating time was significantly shortened to 7 days or less.

In Comparative Example 3, it was confirmed that since the contents of chlorine (Cl) and nitrogen (N) in the kero− and LGO+ oil fractions were excessive, an ammonium salt (NH₄Cl) occurred and a reaction differential pressure was increased, so that the maximum operating time was significantly shortened to 4 days.

1. Waste plastic pyrolysis oil refining equipment comprising:
a separation unit which separates a waste plastic pyrolysis oil into a light oil and a heavy oil;
a first reactor which hydrotreats the light oil introduced from the separation unit at a temperature of higher than 300° C. and lower than 400° C. in the presence of a hydrotreating catalyst;
a separator which removes hydrogen chloride from a reaction product introduced from the first reactor; and
a second reactor which removes impurities from the heavy oil introduced from the separation unit at a temperature of higher than 50° C. and lower than 300° C.

2. The waste plastic pyrolysis oil refining equipment of claim 1, wherein the light oil has a boiling point of lower than 180° C., and the heavy oil has a boiling point of higher than 180° C., in the separation unit.

3. The waste plastic pyrolysis oil refining equipment of claim 1, wherein the light oil contains 800 ppm or more and 3300 ppm or less of chlorine (Cl) and 200 ppm or more and 1100 ppm or less of nitrogen (N), and the heavy oil contains 200 ppm or more and 500 ppm or less of chlorine (Cl) and 1200 ppm or more and 1700 ppm or less of nitrogen (N), in the separation unit.

4. The waste plastic pyrolysis oil refining equipment of claim 1, wherein a reaction pressure of the first reactor is 100 bar or less.

5. The waste plastic pyrolysis oil refining equipment of claim 1, wherein the separator further includes a hydrogen gas inlet, and the hydrogen chloride is removed from the reaction product introduced from the first reactor by a hydrogen gas introduced from a hydrogen gas inlet.

6. The waste plastic pyrolysis oil refining equipment of claim 1, wherein the second reactor includes a first reaction area where the heavy oil introduced from the separation unit is dechlorinated in the presence of the hydrotreating catalyst; and a second reaction area where a remaining chlorine component is removed from the reaction product introduced from the first reaction area in the presence of an adsorbent.

7. The waste plastic pyrolysis oil refining equipment of claim 1, wherein the second reactor performs an impurity removal reaction of the heavy oil introduced from the separation unit under an inert atmosphere in the presence of a solid acid catalyst.

8. The waste plastic pyrolysis oil refining equipment of claim 7, wherein the second reactor performs a reaction at a pressure of 30 bar or less under a nitrogen atmosphere.

9. The waste plastic pyrolysis oil refining equipment of claim 1, further comprising: a reforming unit which catalytically reforms a first oil fraction, the first oil fraction from which hydrogen chloride has been removed being introduced from the separator.

10. The waste plastic pyrolysis oil refining equipment of claim 1, further comprising: a fractional distillation unit which separates a second oil fraction into two or more oil fractions having different boiling points and refines the oil fractions, the second oil fraction from which impurities have been removed being introduced from the second reactor.

11. A method of refining a waste plastic pyrolysis oil, the method comprising:
separating a waste plastic pyrolysis oil into a light oil and a heavy oil;
(a-1) hydrotreating the light oil at a temperature of higher than 300° C. and lower than 400° C. in the presence of a hydrotreating catalyst;
(a-2) mixing the hydrotreated light oil with a hydrogen gas to remove hydrogen chloride; and
(b-1) removing impurities from the heavy oil at a temperature of higher than 50° C. and lower than 300° C.

12. The method of refining a waste plastic pyrolysis oil of claim 11, wherein the light oil has a boiling point of lower than 180° C., and the heavy oil has a boiling point of higher than 180° C.

13. The method of refining a waste plastic pyrolysis oil of claim 11, wherein the light oil contains 800 ppm or more and 3300 ppm or less of chlorine (Cl) and 200 ppm or more and 1100 ppm or less of nitrogen (N), and the heavy oil contains 200 ppm or more and 500 ppm or less of chlorine (Cl) and 1200 ppm or more and 1700 ppm or less of nitrogen (N).

14. The method of refining a waste plastic pyrolysis oil of claim 11, wherein the hydrotreating (a-1) is performed at a reaction pressure of 100 bar or less.

15. The method of refining a waste plastic pyrolysis oil of claim 11, wherein in the removing of impurities (b-1), the heavy oil is dechlorinated in the presence of a hydrotreating catalyst and then a remaining chlorine component is removed from the heavy oil in the presence of an adsorbent.

16. The method of refining a waste plastic pyrolysis oil of claim 11, wherein in the removing of impurities (b-1), the heavy oil is reacted at a pressure of 30 bar or less under a nitrogen atmosphere in the presence of a solid acid catalyst.

17. The method of refining a waste plastic pyrolysis oil of claim 11, further comprising: (a-3) performing catalytic reforming after the further removing of hydrogen chloride (a-2).

18. The method of refining a waste plastic pyrolysis oil of claim 11, further comprising: (b-2) separating the heavy oil fraction into two or more oil fractions having different boiling points from each other and refining the oil fractions, after the removing of impurities (b-1).
